(19) United States
(12) Patent Application Publication
(10) Pub. No.: US 2009/0323599 A1
(43) Pub. Date: Dec. 31, 2009

(54) METHOD OF RECEIVING/TRANSMITTING AT LEAST ONE SERVICE IN A MOBILE COMMUNICATION SYSTEM

(76) Inventors: Young Dae Lee, Gyeonggi-do (KR); Sung Duck Chun, Gyeonggi-do (KR); Myung Cheul Jung, Seoul (KR); Sung Jun Park, Gyeonggi-do (KR); Patrick Fisher, Bourg la Rein (FR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/159,590

(22) PCT Filed: Dec. 8, 2006
(86) PCT No.: PCT/KR2006/005338

§ 371 Date: Jun. 22, 2009

(30) Foreign Application Priority Data
Jan. 3, 2006 (KR) 1020060000590

(51) Int. Cl. H04W 72/00

(52) U.S. Cl. 370/329; 455/450

(57) ABSTRACT

The present invention relates to a method of controlling resources in a mobile communication system. In one embodiment of the present invention, a UE obtains information necessary for receiving a first service from a network node. The UE calculates resources needed for receiving the first service and a second service simultaneously based on the obtained information and transmits information associated with the calculated resources. The network node performs a scheduling of data transmission for transmitting the first and second service based on the resource information from the UE, so that the UE receives the first and second service without error.

### TECHNICAL FIELD

The present invention relates to a mobile communication system, more particularly, to a method of receiving/transmitting at least one service in a mobile communication system.

### BACKGROUND ART

FIG. 1 is a block diagram of a network structure of E-UMTS (Evolved-Universal Mobile Telecommunications System) to which a related art and the present invention are applicable. An E-UMTS is a system evolving from the conventional UMTS and its basic standardization is currently handled by the 3GPP.

Referring to FIG. 1, an E-UMTS network includes a user equipment (hereinafter abbreviated ‘UE’), a base station (hereinafter named ‘eNode B’) and an access gateway (hereinafter abbreviated ‘AG’) connected to an external network by being located at an end of the E-UMTS network. The eNode B includes at least one cell.

Layers of a radio interface protocol between a UE and a network can be classified into a first layer L1, a second layer L2 and a third layer L3 based on three lower layers of OSI (open system interconnection) reference model widely known in communication systems. A physical layer belonging to the first layer L1 offers an information transfer service using a physical channel. A radio resource control (hereinafter abbreviated ‘RRC’) located at the third layer plays a role in controlling radio resources between the UE and the network. For this, the RRC layer enables RRC messages to be exchanged between the UE and the network. The RRC layer can be distributively located at network nodes including an eNode B, an AG and the like or at either the Node B or the AG.

FIG. 2 is an architectural diagram of a control plane of a radio interface protocol between a UE (user equipment) and a UTRAN (UMTS terrestrial radio access network) based on the 3GPP radio access network standard. Referring to FIG. 2, a radio interface protocol vertically includes a physical layer, a data link layer, and a network layer and horizontally includes a user plane for data information transfer and a control plane for signaling transfer. The protocol layers in FIG. 2 can be classified into L1 (first layer), L2 (second layer), and L3 (third layer) based on three lower layers of the open system interconnection (OSI) standard model widely known in the communications systems.

The respective layers of a radio protocol control plane shown in FIG. 2 and a radio protocol user plane shown in FIG. 3 are explained as follows.

First of all, the physical layer as the first layer offers an information transfer service to an upper layer using physical channels. The physical layer (PHY) is connected to a medium access control (hereinafter abbreviated ‘MAC’) layer above the physical layer via transport channels. Data are transferred between the medium access control layer and the physical layer via the transport channels. Moreover, data are transferred between different physical layers, and more particularly, between one physical layer of a transmitting side and the other physical layer of a receiving side via the physical channels.

The medium access control (hereinafter abbreviated ‘MAC’) layer of the second layer offers a service to a radio link control (hereinafter abbreviated RLC) layer above the MAC layer via logical channels.

The RLC layer of the second layer supports reliable data transfer. A PDCP layer of the second layer performs a header compression function for reducing unnecessary control information to efficiently transmit data, which is transmitted using such an IP packet as IPv4 or IPv6, in a radio section having a relatively small bandwidth.

A radio resource control (hereinafter abbreviated ‘RRC’) layer located on a lowest part of the third layer is defined in the control plane only and is associated with configuration, reconfiguration and release of radio bearers (hereinafter abbreviated ‘RBs’) to be in charge of controlling the logical, transport and physical channels. In this case, the RB means a service offered by the second layer for the data transfer between the UE and the UTRAN.

As a downlink transport channel carrying data to UEs from the network, there is a broadcast channel (BCH) carrying system information and a downlink shared channel (SCH) carrying user traffic or control messages. The traffic or control messages of a downlink multicast or broadcast service can be transmitted via the downlink SCH or a separate downlink multicast channel (MCH). Meanwhile, as an uplink transport channel carrying data to the network from UEs, there is a random access channel (RACH) carrying an initial control message and a uplink shared channel (UL-SCH) carrying user traffic or control message.

### DISCLOSURE OF INVENTION

In the related art, a network of a mobile communication system may not realize that a UE is receiving a point-multipoint service through a point-to-multipoint radio bearer. Further, the network is not able to recognize an amount of resources which the UE is using for receiving the point-multipoint service. For example, when the UE receives a UE-dedicated service and a point-multipoint service simultaneously, the network cannot recognize UE capability used for receiving the UE-dedicated service or the point-multipoint service among the total UE capability. Accordingly, there can be a problem that the UE is not able to normally receive the UE-dedicated service or the point-multipoint service, when the network provides the UE-dedicated service or the point-multipoint service while the UE receives the point-multipoint service or the UE-dedicated service, respectively.

Accordingly, the present invention is directed to a method of receiving/transmitting at least one service a mobile communication system that substantially obviates one or more of the problems due to limitations and disadvantages of the related art.

In one embodiment of the present invention, a UE obtains information necessary for receiving a first service from a network node. The UE calculates resources needed for receiving the first service and a second service simultaneously based on the obtained information and transmits information associated with the calculated resources. The network node performs a scheduling of data transmission for transmitting the first and second service based on the resource information from the UE, so that the UE receives the first and second service without error.

As another aspect of the present invention to achieve these and other advantages, as embodied and broadly described, a method of receiving at least one service at a user equipment in a communication system comprises receiving control information or data associated with a second service from a network, wherein the user equipment receives the first service, estimating resources necessary for receiving at least one of the first service and the second service, and transmitting resource information associated with the estimated resources to the network.

To further achieve these and other advantages and in accordance with the purpose of the present invention, a method of transmitting at least one service to a user equipment in a network, comprising transmitting control information or data associated with a second service to the user equipment, wherein the network transmits a first service, receiving resource information associated with resources necessary for the user equipment to receive at least one of the first service and the second service from the user equipment, and performing scheduling of transmission for the at least one of first service and the second service based on the resource information.

The resources are UE resources necessary for the UE to receive the first service and/or the second service. For example, the resources may include at least one of an amount of data per time unit which the UE can process, a transmitting or receiving bandwidth, and an automatic repeat request (ARQ) capacity, etc.

The control information associated with at least one of a first and second service may includes a bandwidth for receiving the at least one of a first and second service, transmission power, transmission data rate, a scheme of channel coding and modulation, data sizes, etc. The network may be at least one of a base station, a Node B, an eNode B, a base station controller, and radio network controller (RNC). The first service is a point-multipoint service and the second service is a UE-dedicated service, and vice versa.

The resource information transmitted from the UE to the network node may include UE capability to be used for receiving at least one of the first and second services. For example, the resource information includes information associated with bandwidth for the first service and/or the second service, ARQ parameters, data sizes, transmission power, data rate, and a scheme of channel coding and modulation, etc. The resource information may further include a service identifier, a radio bearer identifier or a channel identifier for the first service and/or the second service.

The resource information can be transmitted periodically by the UE in accordance with instructions of the network node. Alternatively, the UE transmits the resource information to the network node when the UE has or is expected to have difficulties in receiving the first service and/or the second service due to limitations of resources. The network node controls transmission of data for the first service and/or the second service using the resource information received from the UE.

The UE can dynamically update the UE capability according to a combination of received services. Alternatively, the UE may dynamically update scheduling information of data transmission of the network node.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of a network structure of E-UMTS (evolved universal mobile telecommunications system);

FIG. 2 is an architectural diagram of a control plane of a radio interface protocol between UE (user equipment) and UTRAN (UMTS terrestrial radio access network) based on the 3GPP radio access network standard;

FIG. 3 is a diagram of various layers in a radio protocol user plane;

FIG. 4 is a flow diagram illustrating a method of controlling transmission resources in a mobile communication system in accordance with one embodiment of the present invention; and

FIG. 5 is a flow diagram illustrating a method of controlling transmission resources in a mobile communication system in accordance with another embodiment of the present invention.

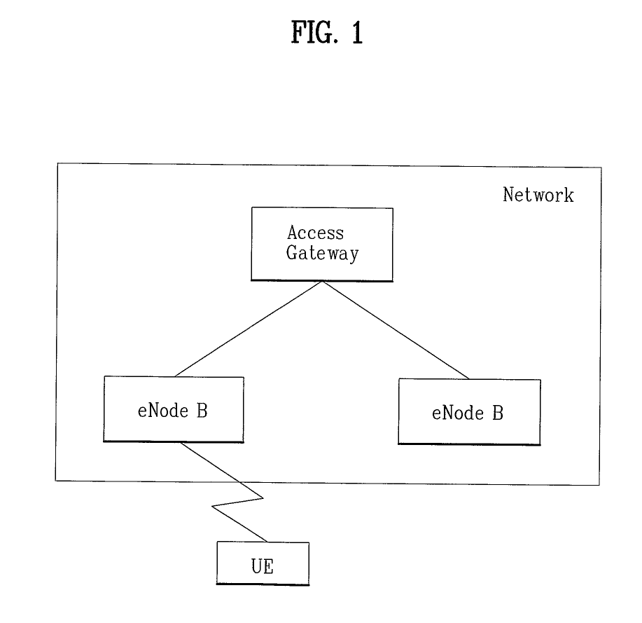

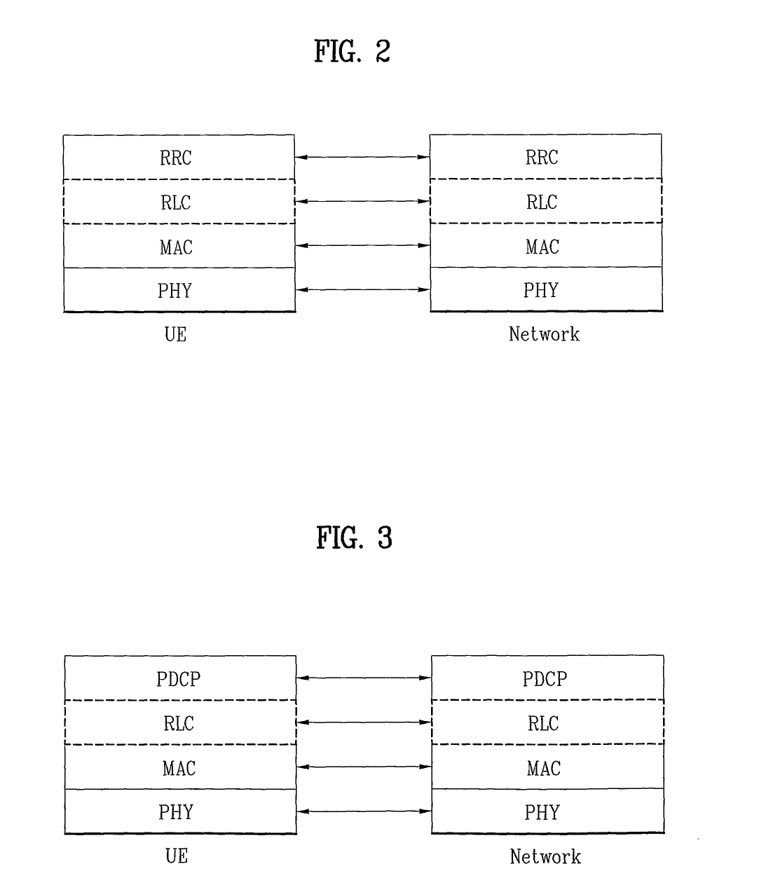

### BEST MODE FOR CARRYING OUT THE INVENTION

Reference will now be made in detail to the preferred embodiments of the present invention, examples of which are illustrated in the accompanying drawings.

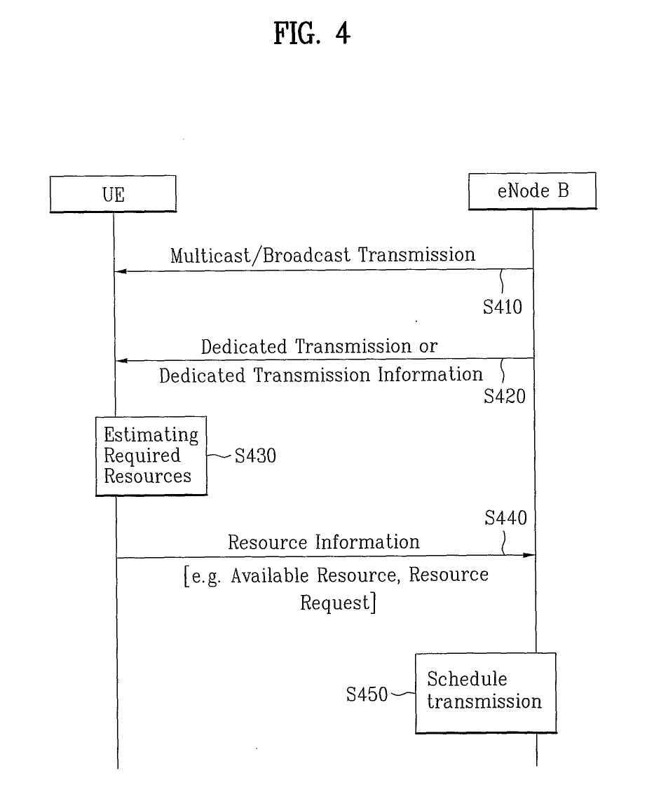

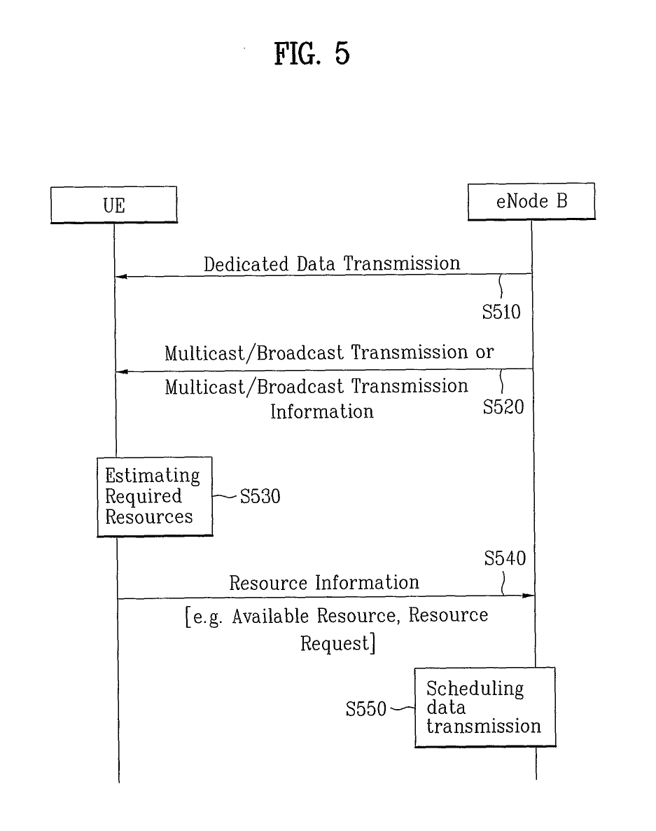

FIG. 4 is a flow diagram illustrating a method of controlling transmission resources in a mobile communication system in accordance with one embodiment of the present invention. The embodiment of FIG. 4 is an example that a UE receives a UE-dedicated service while the UE has been receiving a multicast/broadcasting service which is an example of a point-to-multipoint service.

Referring to FIG. 4, a UE is receiving data for a multicast/broadcasting service transmitted from an eNode B [S410]. The UE receives data for a UE-dedicated service or information associated with the data for the UE-dedicated service from the eNode B [S420]. The information associated with the data for the UE-dedicated service can be included to be transmitted in a paging message for the UE, a channel configuration message, a resource allocation message or a radio bearer configuration message related with the UE-dedicated service. The information associated with the data for the UE-dedicated service may includes transmission parameters (a size of data, a number of channel codes, bandwidth, a scheme of channel coding and modulation, ARQ parameters, etc.) and UE-capabilities for receiving the UE-dedicated service. In FIG. 4, the sequence of S410 and S420 can be changed.

The UE estimates resources available for receiving the multicast/broadcasting service and/or the UE-dedicated service and the UE determines whether it is possible to receive both the multicast/broadcasting service and the UE-dedicated service with total resources of the UE [S430]. Alternatively, the UE calculates resources required for receiving the multicast/broadcasting service, and/or the UE-dedicated service.

The UE transmits resource information including the estimated resources available for receiving the multicast/broadcasting service and/or the UE-dedicated service [S440]. The available resources are UE capabilities available for receiving the multicast/broadcasting service and/or the UE-dedicated service at a current status of the UE. For example, the available resources may include at least one of an amount of data per time unit which the UE can process, the number of channel codes available, a transmitting or receiving bandwidth, and a scheme of channel coding and modulation, etc.

Alternatively, the UE may request transmission parameters for data transmission of the multicast/broadcasting service and/or the UE-dedicated service to the eNode B using the resource information. Here, the transmission parameters may include at least one of an amount of data per time unit which the UE can process (i.e., data rate), the number of channel codes available, a transmitting or receiving bandwidth, a scheme of channel coding and modulation, and ARQ parameters, etc. The UE may include a service identifier, a radio bearer identifier or a channel identifier for a service which is being received or will be received in the resource information to be transmitted.

The eNode B performs scheduling for data transmission of the multicast/broadcasting service and/or the UE-dedicated service based on the available resources or the transmission parameters received from the UE [S450].

The S440 step can be performed a prescribed number of times or repeated periodically or non-periodically. The eNode B may transmit to the eNode B information on whether the S440 step is performed the prescribed number of times or repeated periodically or non-periodically. For instance, the UE may perform the S440 step periodically according to a notification from the eNode B.

Alternatively, the UE may perform the S440 step in accordance with a condition varying due to a change of UE resources or communication environment. For example, the S440 step is performed by the UE in case that a problem occurs or is expected to occur when receiving the multicast/broadcasting service and the UE-dedicated service simultaneously with current resources of the UE.

FIG. 5 is a flow diagram illustrating a method of controlling transmission resources in a mobile communication system in accordance with another embodiment of the present invention. The embodiment of FIG. 5 is an example that a UE receives a multicast/broadcasting service while the UE is receiving a UE-dedicated service.

Referring to FIG. 5, a UE is receiving data for a UE-dedicated service transmitted from an eNode B [S510]. The UE receives data for a multicast/broadcasting service or information associated with the data for the multicast/broadcasting service from the eNode B [S520]. The information associated with the data for the multicast/broadcasting service can be included to be transmitted in a paging message for the UE, a channel configuration message, a resource allocation message or a radio bearer configuration message related with the multicast/broadcasting service. The information associated with the data for the multicast/broadcasting service may includes transmission parameters (a size of data, a number of channel codes, bandwidth, a scheme of channel coding and modulation, ARQ parameters, etc.) and UE-capabilities for receiving the multicast/broadcasting service. In FIG. 5, the sequence of S510 and S520 can be changed.

The UE estimates resources available for receiving the multicast/broadcasting service and/or the UE-dedicated service and the UE determines whether it is possible to receive both the multicast/broadcasting service and the UE-dedicated service with total resources of the UE [S530]. Alternatively, the UE calculates resources required for receiving the multicast/broadcasting service and/or the UE-dedicated service.

The UE transmits resource information including the estimated resources available for receiving the multicast/broadcasting service and/or the UE-dedicated service [S540]. The available resources are UE capabilities which can be used for receiving the multicast/broadcasting service and/or the UE-dedicated service at a current status of the UE. For example, the available resources may include at least one of an amount of data per time unit which the UE can process, the number of channel codes available, a transmitting or receiving bandwidth, and a scheme of channel coding and modulation, etc.

Alternatively, the UE may request transmission parameters for data transmission of the multicast/broadcasting service and/or the UE-dedicated service to the eNode B using the resource information. Here, the transmission parameters may include at least one of an amount of data per time unit which the UE can process (i.e., data rate), the number of channel codes available, a transmitting or receiving bandwidth, a scheme of channel coding and modulation, and ARQ parameters, etc. The UE may include a service identifier, a radio bearer identifier or a channel identifier for a service which is being received or will be received in the resource information to be transmitted.

The eNode B performs scheduling for data transmission of the multicast/broadcasting service and/or the UE-dedicated service based on the available resources or the transmission parameters received from the UE [S550].

The S540 step can be performed a prescribed number of times or repeated periodically or non-periodically. The eNode B may transmit, to the eNode B, information on whether the S540 step is performed the prescribed number of times or repeated periodically or non-periodically. For instance, the UE may perform the S540 step periodically according to notifications from the eNode B.

Alternatively, the UE may perform the S540 step in accordance with a condition varying due to a change of UE resources or communication environment. For example, the S540 step is performed by the UE in case that a problem occurs or is expected to occur when receiving the multicast/broadcasting service and the UE-dedicated service simultaneously with current resources of the UE.

According to the present invention, UEs are capable of receiving multiples services without error or seamlessly in consideration of total UE capacities.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention is applicable to such a wireless communication system as wireless Internet, mobile communication system and the like.

1. A method of receiving at least one service at a user equipment in a communication system, comprising:
receiving control information or data associated with a second service from a network, wherein the user equipment receives the first service;
estimating resources necessary for receiving at least one of the first service and the second service; and
transmitting resource information associated with the estimated resources to the network.

2. The method of claim 1, wherein the control information or data is included in at least one of a paging message, a channel configuration message, a resource allocation message, and a radio bearer configuration message.

3. The method of claim 1, wherein the resource information includes available resources for receiving the first service and/or the second service.

4. The method of claim 3, wherein the available resources is a capability of the user equipment.

5. The method of claim 1, further comprising receiving the first service and the second service, wherein the first service and the second service are scheduled in the network based on the resource information.

6. The method of claim 1, wherein the resource information includes at least one of an amount of data which the user equipment is able to process at a time unit, an available bandwidth, and a capacity for ARQ (Automatic Repeat reQuest) process.

7. The method of claim 1, wherein the control information or data includes at least one of a bandwidth, transmission power, data rate, a scheme of channel coding and modulation, a size of data for the second service.

8. The method of claim 1, wherein the resource information is transmitted periodically.

9. The method of claim 1, wherein the resource information is transmitted to the network when a notification from the network is received.

10. The method of claim 1, wherein a network node in the network is any one of a base station, a Node B, an eNode B, a base station controller, and a radio network controller (RNC).

11. The method of claim 1, wherein the first service is a point-to-multipoint service and the second service is a dedicated service.

12. The method of claim 11, wherein the point-to-multipoint service is a Multicast/Broadcast service and the dedicated service is a UE-dedicated service.

13. A method of transmitting at least one service to a user equipment in a network, comprising:
transmitting control information or data associated with a second service to the user equipment, wherein the network transmits a first service;
receiving resource information associated with resources necessary for the user equipment to receive at least one of the first service and the second service from the user equipment; and
performing scheduling of transmission for the at least one of first service and the second service based on the resource information.

14. The method of claim 13, wherein the control information or data is included in at least one of a paging message, a channel configuration message, a resource allocation message, and a radio bearer configuration message.

15. The method of claim 13, wherein the resource information includes available resources for receiving the first service and/or the second service.

16. The method of claim 15, wherein the available resources is a capability of the user equipment.

17. The method of claim 13, wherein the resource information includes at least one of an amount of data which the user equipment is able to process at a time unit, an available bandwidth, and a capacity for ARQ (Automatic Repeat reQuest) process.

18. The method of claim 13, wherein the control information or data includes at least one of a bandwidth, transmission power, data rate, a scheme of channel coding and modulation, a size of data for the second service.

19. The method of claim 13, wherein the resource information received periodically.

20. The method of claim 13, wherein the network node is any one of a base station, a Node B, an eNode B, a base station controller, and a radio network controller (RNC).

21. The method of claim 13, wherein the first service is a point-to-multipoint service and the second service is a dedicated service.

22. The method of claim 21, wherein the point-to-multipoint service is a multicast/broadcasting service and the dedicated service is a UE-dedicated service.
